(19) United States
(12) Patent Application Publication
(10) Pub. No.: US 2025/0136452 A1
(43) Pub. Date: May 1, 2025

(54) Highly Porous Max Phase Precursor For Mxene

(71) Applicants: Drexel University, Philadelphia, PA (US); Materials Research Center Ltd., Kyiv (UA); Y-Carbon Ltd., Kyiv (UA)

(72) Inventors: Yury Gogotsi, Ivyland, PA (US); Oleksiy Gogotsi, Kyiv (UA); Iryna Roslyk, Elmer, NJ (US); Veronika Zahorodna, Mankivka (UA); Ivan Baginskiy, Kyiv (UA); Robert Lord, Chandler, AZ (US)

(21) Appl. No.: 18/919,712

(22) Filed: Oct. 18, 2024

Related U.S. Application Data
(60) Provisional application No. 63/593,118, filed on Oct. 25, 2023.

(51) Int. Cl. C01B 32/921; C01B 32/907

(52) U.S. Cl. CPC C01B 32/921; C01B 32/907; C01P 2002/72; C01P 2002/84; C01P 2004/03; C01P 2004/04; C01P 2004/20; C01P 2004/61; C01P 2006/40

(57) ABSTRACT

A method, comprising: forming a porous MAX-phase material. A MAX-phase material, the MAX-phase material made according to the present disclosure. A MXene material, the MXene material formed by removal of the A-group element of a MAX-phase material made according to the present disclosure.

### CROSS-REFERENCE TO RELATED APPLICATIONS

This application claims benefit to U.S. Provisional Application No. 63/593,118, filed Oct. 25, 2023. All foregoing applications are incorporated herein by reference in their entireties for any and all purposes.

### GOVERNMENT RIGHTS

This invention was made with government support under Contract No. DE-SC0018618 awarded by the Department of Energy. The government has certain rights in the invention.

### TECHNICAL FIELD

The present disclosure relates to the field of material science and to the fields of MAX-phase and MXene materials.

### BACKGROUND

Since MXenes' discovery, obtaining porous MAX phase precursors, such as Ti₃AlC₂, for the synthesis of MXenes, such as Ti₃C₂, became an important task. The low-density MAX phase can be crushed into powder with little force and without extensive milling. This not only decreases the cost of manufacturing, but also avoids lattice distortion of the MAX phase and produces a higher quality MXene. Conventionally, MAX phases are produced by hot pressing, hot isostatic pressing, or pressureless sintering, as they were developed for structural applications requiring dense and mechanically strong materials. All those methods lead to hard and strong sintered bodies that require crushing and high-energy milling to produce a powder. A traditional approach to manufacturing porous Ti—Al—C and some other ceramics is to add different additives in the mixture such as NaCl that prevent complete sintering and can be removed during or after processing. However, any addition to the mixture can lead to contamination of the MAX phase and MXenes, as well as affect the stoichiometry, purity, and properties of the materials.

### SUMMARY

This invention is directed to a process for making a porous sintered Ti₃AlC₂ or another MAX phase ceramic, which takes carbon or a metal carbide (e.g., titanium carbide), aluminum powder and titanium sponge powder as the raw materials. They are weighed and mixed in the molar ratio for the desired MAX phase synthesis (e.g., 2:2.2:1.25 TiC:Al:Ti), forming a homogeneous mixture, pressed into a pellet; sintered under argon or another protective atmosphere at above the melting points of aluminum and below the decomposition point of the MAX phase (e.g., at 1380-1420° C. for Ti₃AlC₂) for 2-4 hours or whatever the time required to complete the reaction and a ceramic workpiece with less than 45% of theoretical density.

In this invention, titanium sponge as a low-cost and porous 3D titanium metal ensures high porosity and low mechanical strength of sintered bodies. Titanium sponge is mainly used to produce titanium ingot and as a raw material for pure and ductile iodide titanium and titanium alloys. It's at least an order of magnitude less expensive compared to the Ti powder.

We claim manufacturing of porous Ti₃AlC₂ without any pore former using titanium sponge as a source of titanium. The method is applicable to other titanium carbide, nitride and carbonitride MAX phases, as well as Zr MAX phases and other materials for which inexpensive metal sponges are available. Multiple experimental samples have been manufactured using this method in our laboratories, covering a range of compositions and experimental conditions.

In one aspect, the present disclosure provides a method, comprising: forming a porous MAX-phase material.

Also provided is a MAX-phase material, the MAX-phase material made according to the present disclosure.

Further provided is a MXene material, the MXene material formed by removal of the A-group element of a MAX-phase material made according to the present disclosure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 Process flow chart and raw materials: (a) fine Al, (b) coarse Al, (c) sponge Ti, (d) fine Ti.

FIG. 2. Pictures of sintered bodies after MAX synthesis. (a) Fine Ti and fine Al, (b) sponge Ti and fine Al, (c) sponge Ti (fraction <75 μm) and fine Al, (d) fine Ti and coarse Al.

FIG. 3. Characterization of MAX phases. (a) XRD patterns of samples produced with fine and coarse Ti sponge, SEM images of MAX phases produced with (b) fine Ti and (c) coarse Ti sponge.

FIG. 4. Schematic of MXene synthesis (a), AFM images of and flake size distributions of delaminated Ti₃C₂Tₓ produced with fine Ti (b, c) and coarse Ti sponge (d, e). AFM statistical analysis was performed on 100 individual flakes of delaminated Ti₃C₂Tₓ, produced from (b, c) fine Ti and (d, e) coarse Ti sponge.

FIG. 5. (a) XRD patterns of delaminated Ti₃C₂Tₓ. Insets show Ti₃C₂Tₓ films (4 cm diameter) produced by vacuum-assisted filtration. (b) UV-vis spectra of delaminated Ti₃C₂Tₓ produced from MAX phases obtained using fine and coarse Ti powders.

FIG. 6. SEM image (a) and XRD pattern (b) of coarse Ti sponge.

FIG. 7. Photograph of a MAX phase sample made with coarse Ti sponge and sintered at 1380° C.

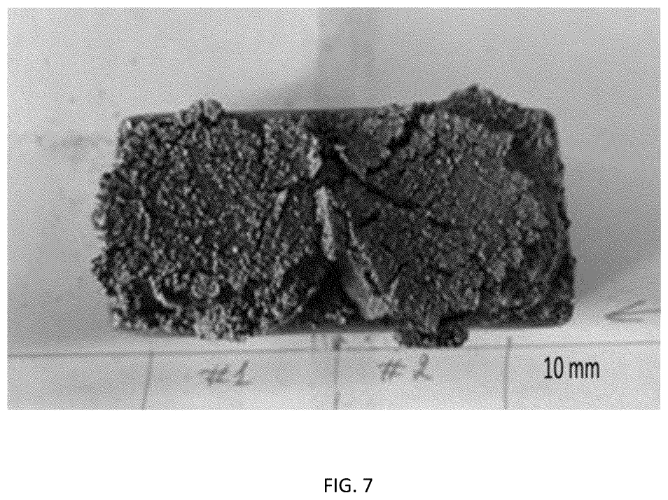

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety.

The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

MXenes, a large family of 2D carbides and/or nitrides, are among the most studied materials worldwide due to their great diversity of structures and compositions. Their unique properties are finding use in several applications, ranging from printable electronics and communication to energy storage and healthcare. Typically, they are manufactured by selective wet-chemical etching of layered MAX phase ceramics, which are produced nowadays primarily for MXene synthesis. However, the synthesis of MAX phases has not been changed since the time of their use in structural and high-temperature applications, and it has not been optimized for MXene manufacturing. The main purpose of this study is to develop a porous Ti₃AlC₂ MAX phase that can be easily ground into individual grains without time-consuming, harsh, and tedious crushing and milling steps. Moreover, we also demonstrate the synthesis of highly porous Ti₃AlC₂ from an inexpensive titanium sponge instead of a highly pure and fine titanium powder, as well as explaining the mechanisms of reaction sintering and formation of porous MAX phase. The developed Ti₃AlC₂ synthesis protocol is commercially relevant as it saves time, decreases the costs, minimizes the content of secondary phases in the reaction products, and leads to high-quality Ti₃C₂Tₓ MXene. In fact, MXenes obtained from this MAX phase show larger flake size and higher electrical conductivity in thin films, compared to the materials produced from the costly fine titanium powder. The proposed approach may apply to the synthesis of other MAX phases as well.

In this invention, we obtain a highly porous MAX phase, such as Ti₃AlC₂, by using much less expensive raw material (e.g., titanium sponge) instead of the metal or hydride or carbide powder, aluminum and carbon for preparing MAX phase.

The produced porous material can be easily crushed into powder, which leads to a significant cost reduction by elimination of hard crushing/milling and high-energy ball milling.

Decreased wear of milling equipment and milling bodies not only saves costs, but also minimizes impurities in MAX and the subsequent MXenes.

Decreased distortion and damage of MAX due to avoiding high-energy milling leads to a lower concentration of defects in the MAX crystal lattice and MXene, increasing the properties (strength, conductivity, environmental stability) of the end-product MXene produced by selectively etching the MAX phase and its flake size.

### INTRODUCTION

Ternary layered carbides and/or nitrides, known as MAX phases, represent a large class of materials with a general formula Mₙ₊₁AXₙ, where M is a transition metal, A is an element from the p-block, mostly groups 13 and 14 of the periodic table, and X is C and/or N, with n=from 1 to 5.^{1,2} They possess a unique combination of physicochemical properties, exhibiting some characteristics of ceramics and others of metals. In this regard, MAX phases have been considered for several different applications in aerospace and automotive industries as high-temperature elements, friction parts, and good electrical and thermal conductors. For those applications, high density, phase purity, and mechanical strength are required. The MAX phase can be fabricated via powder-metallurgical routes, including reactive hot-pressing or hot-isostatic pressing (HIP)^{3.4}, pressureless sintering (PS) under an inert environment⁵, self-propagating high-temperature synthesis (SHS)⁶, spark plasma sintering (SPS)^{7,8}, and other methods. Most of those methods, except for SHS, lead to hard sintered bodies that require crushing and high-energy milling to produce powders.

Since their discovery in 2011, two-dimensional (2D) carbides and/or nitrides, known as MXenes⁹, for which MAX phases serve as precursors, captured the interest of the scientific and industrial communities. Nowadays, MAX phases are produced primarily for the MXene manufacturing.¹⁰ Ti₃C₂Tₓ (Tₓ stands for surface terminations, mainly including —O, —OH, and —F) is the most studied and important MXene, with more than half of all MXene publications dedicated to this material.¹¹ Therefore, Ti₃AlC₂ is the most important and widely manufactured MAX phase, as it is used as the main precursor for Ti₃C₂Tₓ. However, the requirements for MAX phases used to make MXenes differ drastically from those of structural MAX materials. In particular, powders or porous, loosely bonded sintered bodies are needed. Some unreacted metals, intermetallic or oxides are less critical in MXene precursors compared to structural MAX phases. Although they can strongly affect the mechanical properties for structural applications, they can be either dissolved in acids (e.g., HCl or HF) during MXene synthesis or removed during MXene delamination. At the same time, Ti:C stoichiometry in MAX phases, as well as the oxygen presence in the carbon sublattice, which was usually ignored when producing MAX phases, play a critical role in determining the electrical conductivity and environmental stability of MXenes.¹²

A mono-transition MXene can take the form of M₂C, M₃C₂, and M₄C₃. A MXene can also be in double-transition form, which can be M′₂M″C₂ or M′₂M″₂C₃ where M′ and M″ are different transition metals. A solid-solution MXene can take the general formula of: (M′_{2-y}M″_{y})C, (M′_{3-y}M″_{y})C₂, (M′_{4-y}M″_{y})C₃, or (M′_{5-y}M″_{y})C₄.

In certain embodiments, the MXene composition is any of the compositions described in at least one of U.S. patent application Ser. No. 14/094,966 (filed Dec. 3, 2013), 62/055,155 (filed Sep. 25, 2014), 62/214,380 (filed Sep. 4, 2015), 62/149,890 (filed Apr. 20, 2015), 62/127,907 (filed Mar. 4, 2015) or International Applications PCT/US2012/043273 (filed Jun. 20, 2012), PCT/US2013/072733 (filed Dec. 3, 2013), PCT/US2015/051588 (filed Sep. 23, 2015), PCT/US2016/020216 (filed Mar. 1, 2016), or PCT/US2016/028,354 (filed Apr. 20, 2016), preferably where the MXene composition comprises titanium and carbon (e.g., Ti3C2, Ti2C, etc.). Each of these compositions is considered independent embodiment.

Similarly, MXene carbides, nitrides, and carbonitrides are also considered independent embodiments. Various MXene compositions are described elsewhere herein, and these and other compositions, including coatings, stacks, laminates, molded forms, and other structures, described in the above-mentioned references are all considered within the scope of the present disclosure.

A porous and low-density MAX phase that can be crushed into powders with minimal force and without extensive milling steps is highly desired for MXene synthesis. This would not only decrease the cost of MXene manufacturing by eliminating drilling, crushing, and extensive ball-milling, but also prevent lattice distortion of the MAX phase and produce higher quality MXenes with larger flake size and lower concentration of defects. A traditional approach to manufacturing porous materials in the Ti—Al—C systems involves the use of salt additives, such as NaCl¹³ or NH₄HCO₃¹⁴, that prevent complete sintering and can be removed during or after processing. However, their addition may lead to contamination of the MAX phases and MXenes, as well as affecting the stoichiometry, purity, and properties of the resulting materials. That is why the direct synthesis of the low-density MAX phase is preferable.

The composition and porosity of MAX phases are determined not only by the synthesis process, but also by the selection of their precursors. Conventionally, Ti₃AlC₂ is synthesized via high-temperature reactive sintering of pure Ti, Al, and C powders¹⁵⁻¹⁷ or TiC, Al, and Ti powders.^{18,19} Since pure Ti and other transition metal powders are quite expensive, low-cost raw materials are a high priority for industrial manufacturing of MXenes and their MAX precursors. Therefore, inexpensive raw materials, such as TiO₂⁴, TiH₂²⁰, and Al₄C₃^{4,21} have been explored. Different carbon sources can also be used, such as graphite, carbides, or carbon fibers^{19,22}. A study of the effects of three carbon sources—graphite, lampblack, and titanium carbide—on the structure and properties of Ti₃AlC₂ MAX phases, along with their derived Ti₃C₂Tₓ MXenes¹⁹, showed that the MAX synthesis protocol and particle morphology dramatically influence the synthesis, quality, and properties of the resulting MXenes.

Another crucial aspect is represented by the stoichiometric ratio of the reactants. For the typical synthesis of Ti₃AlC₂, the stoichiometric ratio of precursors is 2TiC:1Ti:1Al.²³ However, it was shown that an excess of aluminum in the TiC:Al:Ti mixture leads to the stoichiometric Ti₃AlC₂ MAX phases with no detectable oxygen impurities.²⁴

The main purpose of this study is to fabricate a porous Ti₃AlC₂ MAX phase that can be easily crushed into individual crystals/particles without utilizing any pore-forming additives. Moreover, we demonstrate the synthesis of highly porous Ti₃AlC₂ from inexpensive coarse titanium sponge, instead of the highly pure commercial titanium powders, and explain the mechanisms of reaction sintering and porous MAX phase formation. Titanium sponge is used as a raw material for manufacturing pure and ductile iodide titanium and titanium alloys. It is at least an order of magnitude less expensive compared to the commercial Ti powder. Our Ti₃AlC₂ phase synthesis process is commercially relevant, as it minimizes the amounts of secondary phases, such as TiC or Ti₂AlC, in the reaction products and leads to high-quality as well as highly conductive MXenes. The proposed approach may apply to the synthesis of other Ti-based and beyond-Ti MAX phases.

### EXPERIMENTAL

### Ti₃AlC₂ MAX Phase Synthesis

TiC powder (99.5%, −325 mesh, Alfa Aesar, USA) and aluminum powder (99.5%, −325 mesh, Alfa Aesar, USA) were mixed with titanium powder (99.5%, −325 mesh, Alfa Acsar, USA) or coarse titanium sponge (60-325 mesh, Pyro Chemical Source LLC) in molar ratios 2TiC:2.2Al:1.25Ti, providing an excess of aluminum (Al—Ti₃AlC₂ MAX).²⁴ To prove our hypothesis about the sintering mechanism, we also prepared samples using course atomized aluminum powder PA-1 (450-600 μm, Ukraine) instead of Alfa Acsar Al. The mixing was performed in a ball mill using zirconia beads at 70 rpm for 18 h. A 2:1 mass ratio of zirconia milling beads to the precursor powder mixture was used. The homogeneous mixture was cold pressed in a stainless-steel mold with a pressure of 1000 psi to form a pellet with a diameter of 28 mm.

The sintering of pellets was carried out in a GSL-1700X tube furnace (MTI Corporation, USA) at 1380° C., 1400° C., and 1420° C. for 2 h under an argon flow for a mixture with titanium sponge. Only 1380° and 1400° C. reactions were carried out with fine titanium powders, which react faster compared to the sponge. Synthesis of Ti₃AlC₂ from TiC, Al, and fine Ti was adopted from ref²⁴ suggesting sintering at 1380-1400° C. to obtain pure Ti₃AlC₂. The heating and cooling rates were both 3° C./min. The sintered pellets of Ti₃AlC₂were crushed into powders manually and with a planetary ball mill (for dense samples). For removing impurities, such as intermetallics and oxides, the produced powder was sieved to less than 38 μm particle size and washed in 9 M HCl for 20 h at room temperature while stirring. HCl washing reduced the product mass by 20-25%, due to the dissolution of excess Al and TiAl₃ intermetallic. The washed and dried Ti₃AlC₂ was used to produce Ti₃C₂T_{X}.

### MXene Synthesis

Ti₃C₂Tₓ was produced by selective wet-chemical etching following the previously described protocol.²⁵ One gram of Ti₃AlC₂ powder was slowly added to 20 mL of etchant and stirred at 300 rpm at 35° C. for 24 h. The etchant was a 6:3:1 mixture (by volume) of 12 M HCl, DI water, and 50 wt. % HF (Acros Organics, Fair Lawn, NJ, USA). Multilayered Ti₃C₂Tₓ MXene was intercalated with LiCl (using 1 g of LiCl per gram of Ti₃AlC₂ MAX) dissolved in 50 mL of DI water and stirred at 300 rpm at room temperatures for 24 h. The resulting solution was washed with DI water and centrifuged at 3500 rpm for 5 min. The supernatant was discarded, and the delaminated MXene was redispersed by manual shaking. The washing procedure was repeated until the pH of the mixture was higher than 6. Then, the colloidal solution was centrifuged at 3500 rpm for 60 min, and the supernatant containing delaminated Ti₃C₂Tₓ was collected. The MXene free-standing films were prepared from delaminated Ti₃C₂Tₓ by vacuum-assisted filtration.

### Characterization

The phase analysis of MAX and MXene films was carried out by X-ray diffraction (XRD; Miniflex, Rigaku Corporation, Tokyo, Japan) using Cu K_{α} radiation at 40 kV and 15 mA. Step-scan data (with step size equal to) 0.02° were recorded over a range 3-90° (2θ). Conductivity measurements were performed using a four-point probe (Jandel Engineering Ltd., Bedfordshire, UK) on freestanding MXene films. SEM analysis was performed using a Zeiss Supra 50VP electron microscope. UV-Vis spectra were collected using an Evolution 201 spectrometer (Thermo Scientific, MA, USA) with a 10 mm optical length cuvette and scanning from 200 to 1000 nm. AFM images were taken with a Bruker Dimension Icon microscope under ambient conditions, operating in Tapping Mode and using TESPA-V2 tips with spring constant, k=42 N/m. Images were captured at scan rate of 1 Hz with 1024 lines per image. The statistical analysis was performed on 100 individual Ti₃C₂Tₓ flakes for each sample. The results were fitted by using a log-normal distribution.

### RESULTS AND DISCUSSIONS

### Analysis of MAX Produced Using Different Metal Sources

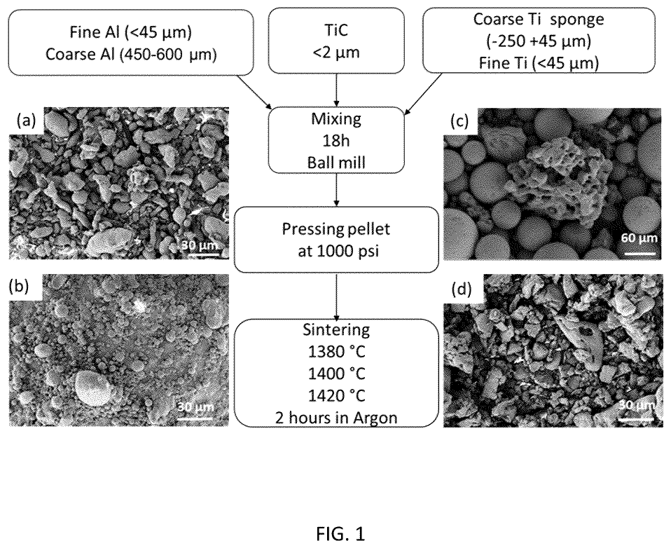

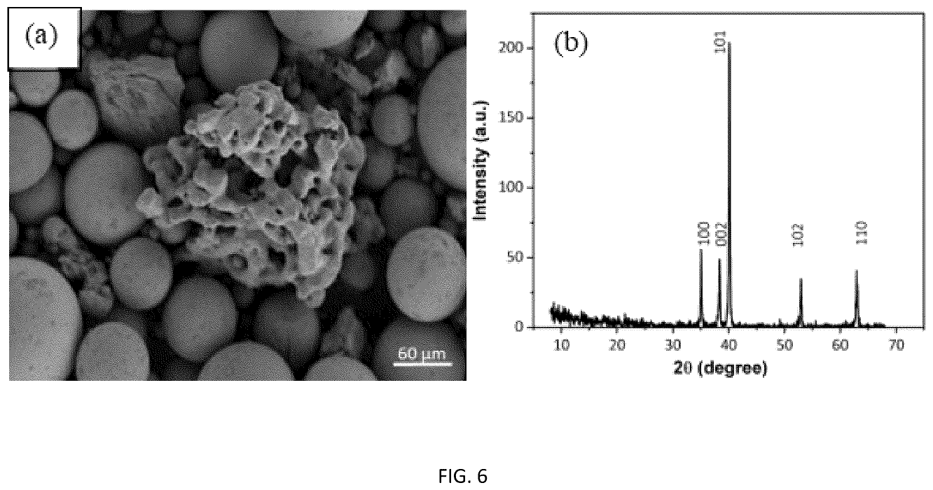

Pressed and sintered Ti₃AlC₂ MAX samples were produced from a mixture of TiC, Al, and Ti powders according to the flow chart shown in FIG. 1. We used the same TiC powder for all samples, but the titanium sources were different. To investigate the effect of particle size on the porosity of sintered pellets of MAX, two grades of titanium powder with particle sizes less than 325 mesh (fine Ti sponge) and 60-325 mesh (coarse Ti sponge) were used. We used fine commercial Ti and coarse Ti sponge powders (Table 3). SEM images of Ti precursors (FIG. 1) show that Ti sponge has a specific spherical shape and a significantly larger particle size than fine titanium. An example Ti sponge XRD pattern in FIG. 6 exhibits five diffraction peaks at 2θ=35° (100), 38.5° (002), 40.2° (101), 53° (102) and 63° (110), which correspond to α-Ti with lattice parameters c=4.6802 Å, a=2.49481. No secondary phases were found.

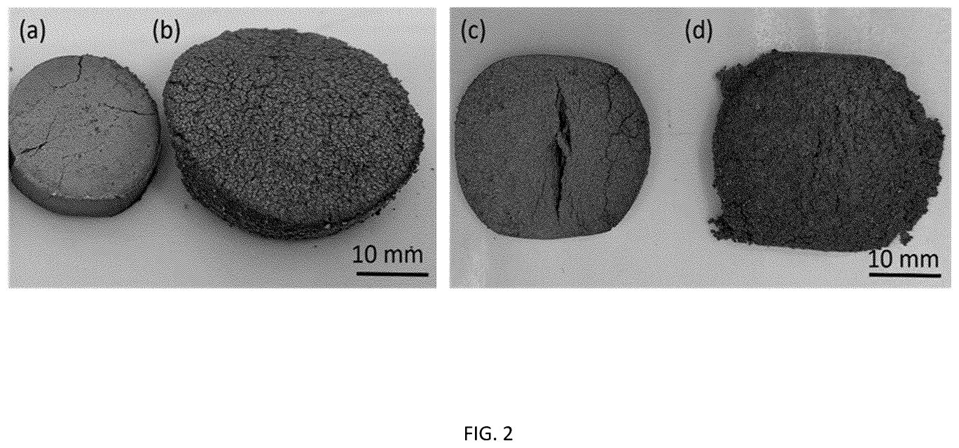

The morphology of samples sintered at 1400° C. is shown in FIG. 2. Samples made from coarse powders increased in volume during the reaction sintering, while shrinkage was observed for samples made with fine powders at all sintering temperatures. The porosity of the sample with coarse Ti after sintering was 73%, compared to 16% for the sample produced using fine Ti. All samples with coarse Ti powders grew after sintering, regardless of temperature. They could be easily crushed by hand into powders, which led to a cost reduction via the elimination of hard crushing/milling and high-energy ball milling. The density and porosity measurements before and after sintering, as well as the shrinkage of the samples, are summarized in Table 4. At 1380° C., pellets with Ti sponge fell apart. In addition, XRD analysis showed TiC presence in this sample (Table 1), demonstrating an incomplete reaction. The temperature of 1380° C. was not sufficient for TiC to react completely with the Ti sponge and Al. Lattice parameters and compositions for all experimental samples are reported in Table 1. For samples with fine and coarse Ti sintered at 1400° C., the c-lattice parameter was the largest, suggesting that they contained less oxygen in the MAX phase lattice.²⁶ TiAl₃ and Al₂O₃ impurities present in the samples were removed during HCl washing, HCl/HF etching of MAX phases, and delamination of MXenes.

TABLE 1
Composition and lattice parameters of two different MAX phases produced by
sintering at 1400° C. using fine titanium powder and coarse titanium sponge.

| | | Lattice | | Lattice | | Lattice |
|---|---|---|---|---|---|---|
| | 1380° C., | parameters, | 1400° C., | parameters, | 1420° C., | parameters, |
| Mixture | mass % | Å | mass % | Å | mass % | Å |
| TiC, Al, | Ti₃AlC₂ - | a: 3.0794 | Ti₃AlC₂ - | a: 3.0838 | — | — |
| Fine Ti | 98.32 | c: 18.5957 | 98.97 | c: 18.6342 | | |
| | Al₂O₃- | a: 4.7591 | Al₃Ti - | a: 3.8546 | | |
| | 0.57 | c: 12.9309 | 1.03 | c: 8.6037 | | |
| | Al₃Ti - | a: 3.8546 | | | | |
| | 1.11 | c: 8.6037 | | | | |
| TiC, Al, | Ti₃AlC₂ - | a: 3.0565 | Ti₃AlC₂ - | a: 3.0770 | Ti₃AlC₂ - | a: 3.0765 |
| Coarse | 97.06 | c: 18.5458 | 97.5 | c: 18.5875 | 99.38 | c: 18.5754 |
| sponge | Al₂O₃ - | a: 4.6600 | Al₂O₃ - | a: 4.7625 | Al₂O₃ - | a: 4.7467 |
| Ti | 0.21 | c: 13.0930 | 1.34 | c: 12.9883 | 0.62 | c: 13.0703 |
| | Al₃Ti- | a: 3.7631 | Al₃Ti- | a: 3.8546 | | |
| | 0.44 | c: 8.5037 | 1.13 | c: 8.6037 | | |
| | TiC - | a: 4.3314 | | | | |
| | 2.29 | | | | | |

To figure out how porosity depends on the particle size of powders, we crushed coarse Ti with a ball mill and a fraction less than 75 μm was added to TiC—Al, pressed, and sintered following the same procedure. This sample also showed some growth (4%), but not as significant as with the coarse Ti sponge. Pictures of sintered bodies are shown in FIGS. 2c and 2d. This experiment suggested that it is not the composition, but the size of the Ti particles that was responsible for the differences in the sintering process. To verify this hypothesis, we produced samples with coarse Al powders. SEM images of coarse Al in FIG. 1b show large spherical particles, which contain more oxygen than fine Al. The porosity of pellets with coarse Al grew up to 50%. Thus, the expansion during the reactive sintering can be explained by the particle size of the metal powders. It is known that nucleation and growth of MAX occur on the carbide.²⁷ The presence of a coarse Ti sponge or Al separated from TiC particles hinders diffusion and reaction with the TiC. During sintering at temperatures 640-670° C., aluminum melts and goes into the liquid phase, forming voids at the place of large metal inclusions. In addition, for the Ti—Al system, the mutual solubility of the components varies greatly. Aluminum dissolves well in both liquid and solid titanium, but the solubility of titanium in aluminum is very low. This fact contributes to the Kirkendall effect (formation of voids) at the Ti—Al interface.^{28,29} This, together with the volume expansion when TiC reacts with Al and Ti, transforming to Ti₃AlC₂, explains the swelling of samples during the sintering and formation of the highly porous MAX phase.

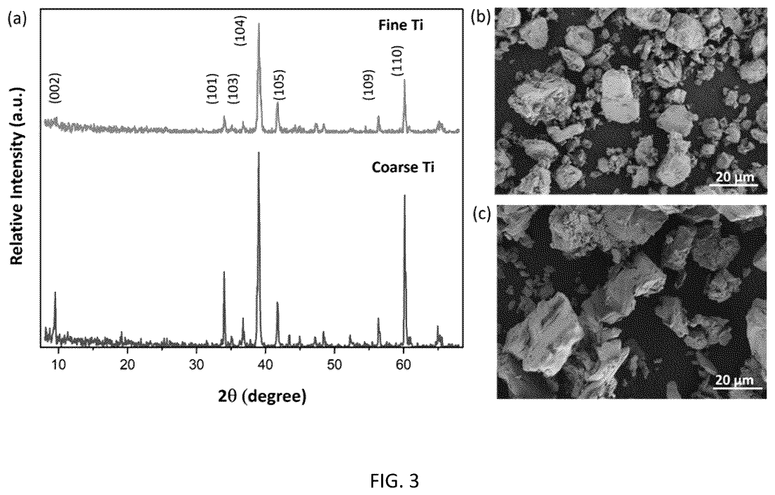

The success of the MAX synthesis was confirmed by the XRD. FIG. 3 shows XRD patterns and SEM images of Ti₃AlC₂ produced at 1400° C. with commercial fine Ti and coarse Ti. For both samples, all peaks expected for the p63/mmc MAX phase structure are observed. The positions of the peaks were almost identical, with non-significant shifts. The only difference was observed in the intensities of the (002), (101), (104) and (110) peaks. For samples with coarse Ti sponge, the peak at 2θ=9.57° (002) is more intense. No peaks related to the Ti₂AlC phase or TiC were observed for both samples. Only the intermetallic compound, TiAl₃, which can be easily removed by HCl washing at room temperature, was present in both samples. The samples with a coarse Ti sponge also had about 1.3% Al₂O₃. SEM images of MAX phase samples (FIG. 3) suggest that layered Ti₃AlC₂ MAX phases with coarse Ti had larger particles than the ones with fine Ti.

### Analysis of MXenes

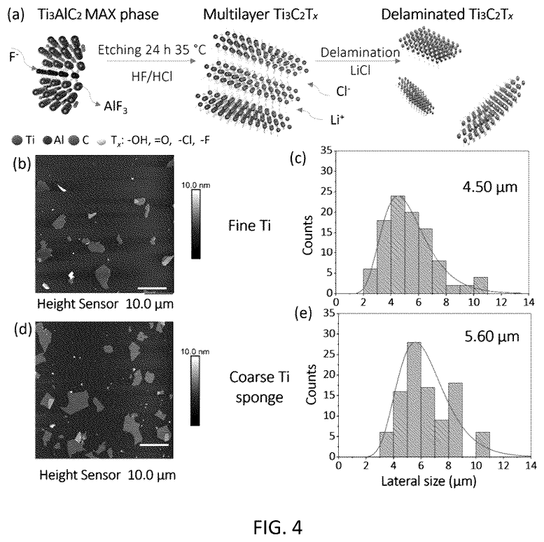

Although the MAX phase purity and crystal size are important, only MXene composition and properties can verify the quality of the MAX precursors. One of the important characteristics of MXenes is their flake size. FIG. 4 shows the AFM statistical analysis of delaminated Ti₃C₂Tₓ samples along with their flake size distribution obtained by mapping over 100 individual flakes. The average lateral size of Ti₃C₂Tₓ flakes from coarse-Ti MAX is larger (5.6 μm, FIG. 4) than flakes from fine-Ti MAX (4.5 μm).

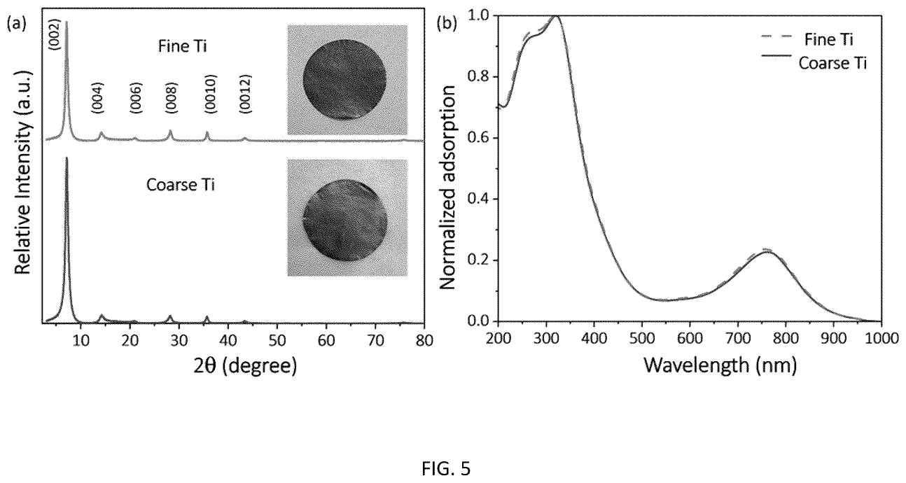

Vacuum-assisted filtration of delaminated Ti₃C₂Tₓ flakes produced shiny, dark-purple, free-standing films with good flexibility (FIG. 5). The XRD measurements show that after etching in HF/HCl/H₂O mixture the Al layer was completely removed from the MAX phases and this led to the disappearance of all the Ti₃AlC₂ related peaks. The (002) peak was shifted toward lower values, from 2θ=9.57° to 7.13°, highlighting the successful formation of MXene. All other peaks for both samples are at the same 2θ values. The peak (002) for the sample with Ti sponge is broader and more intense. Both films have comparable d-spacing values (12.399 Å for fine Ti and 12.356 Å for Ti sponge), indicating that all films have similar quantities of water trapped in between the MXene flakes after drying in air.

Stability studies were performed after synthesis, by diluting each delaminated MXene solution. The UV-visible spectroscopy measurements (FIG. 5) showed a broad absorption peak at 756 nm (fine Ti) and at 760 nm (Ti sponge), which belongs to Ti₃C₂Tₓ, confirming the good stability of both samples.

Four-point probe measurements of vacuum-filtered films showed that the electrical conductivity of Ti₃C₂Tₓ obtained from Ti sponge MAX/MXene reached ˜16,500 S/cm, whereas the MXene films obtained from fine-Ti MAX showed lower conductivity ˜of 11,500 S/cm (Table 2).

TABLE 2
Electrical conductivity of free-standing Ti₃C₂T_{X}
films produced from two different titanium sources.

| | | | Average | |
|---|---|---|---|---|
| | Concentration, | Film mass, | thickness, | Conductivity, |
| Mixture | mg/ml | mg | μm | S/cm |
| Fine Ti | 1.25 | 16.3 | 5.66 | 11,500 |
| Coarse Ti | 1.28 | 18.0 | 4.80 | 16,500 |

This can be explained by the larger flake size for Ti₃C₂ Tₓ from the Ti sponge MAX phases, even though a decreased concentration of defects and other factors may also contribute to MXene electrical properties. Additional in-depth characterizations are needed to fully evaluate the characteristics of MXenes produced using the Ti sponge.

### CONCLUSIONS

In this study, we have optimized the synthesis of MAX phases for MXene manufacturing. The results of this work show that the use of a coarse Ti sponge as a precursor allows the synthesis of pure Ti₃AlC₂ MAX phase with high porosity (about 70%) by using a significantly less expensive raw material. Experiments with different particle sizes of titanium and aluminum powders suggest that the swelling of the pellets during the reaction sintering was mainly due to the large particle size of the metal. The produced MAX phases can be easily crushed by hand, eliminating the need for drilling and intense ball-milling before MXene synthesis. This is advantageous from the standpoint of MXene large-scale synthesis, as well as decreasing the cost and improving the quality of the final materials. MXenes obtained from these MAX phases showed excellent electrical conductivity in thin films and larger flake size compared to the materials produced from the fine Ti powders under the same conditions.

TABLE 3
Characteristics of raw materials used
for the synthesis of MAX phases.

| Raw material | Vendor | Purity and particle size |
|---|---|---|
| Titanium carbide | Alfa Aesar Thermo | 99.5% (metals basis) |
| (TiC) | Fisher Scientific | 2 μm |
| | Chemicals, Inc. | |
| Fine aluminum | Alfa Aesar Thermo | 99.5% |
| powders (Al) | Fisher Scientific | −325 mesh (45 μm) |
| | Chemicals, Inc. | |
| Fine titanium | Alfa Aesar Thermo | 99.5% |
| powders (Ti) | Fisher Scientific | −325 mesh (45 μm) |
| | Chemicals, Inc. | |
| Coarse titanium | Pyro Chemical | Powder 60-325 mesh |
| sponge (Ti Sponge) | Source LLC | (45-250 μm) |

TABLE 4
Characteristics of MAX phase samples
produced using different Ti sources.

| Sample | ρ₁, g/cm³ | ρ₂, g/cm³ | P₁, % | P₂, % | ΔV/V, % |
|---|---|---|---|---|---|
| Fine Ti | 2.60 | 3.52 | 38 | 16.3 | 28 |
| Coarse Ti sponge | 2.74 | 1.12 | 34.8 | 73.4 | −132 |
| Coarse Al | 2.50 | 2.09 | 40.7 | 50.2 | 16 |
| Ti sponge <75 μm | 2.60 | 2.67 | 38.8 | 36.4 | −4 |

ρ₁, ρ₂—density of green and sintered pellets;
P₁, P₂—porosity of green and sintered pellets,
ΔV/V—shrinkage/growth of pellets

### REFERENCES

Barsoum MW. MAX phases. Wiley-VCH. Weinheim. Chichester: 2013. 421 p.
Downes M. Shuck CE. Lord RW. Anaycc M. Shekhirev M. Wang RJ. et al. M₅X₄: A Family of MXenes. ACS Nano. 2023:17(17):17158-68.
Han J-H, Hwang S-S, Lee D, Park S-W. Synthesis and mechanical properties of Ti₃AlC₂ by hot pressing TiCₓ/Al powder mixture. Journal of the European Ceramic Society. 2008;28 (5):979-88.
Tzenov NV, Barsoum MW. Synthesis and Characterization of Ti₃AlC₂. Journal of the American Ceramic Society. 2004;83:825-32.

Wang XH, Zhou YC. Layered Machinable and Electrically Conductive Ti₂AlC and Ti₃AlC₂ Ceramics: a Review. Journal of Materials Science & Technology. 2010;26(5):385-416.
Vorotilo S, Shuck CE, Anayee M, Shekhirev M, Matthews K, Lord RW, et al. Affordable combustion synthesis of V₂AlC precursor for V₂CTₓ MXene. Graphene and 2D Materials. 2023. https://doi.org/10.1007/s41127-023-00059-1
Zhou W, Mei B, Zhu J, Hong X. Synthesis of high-purity Ti₃SiC₂ and Ti₃AlC₂ by spark plasma sintering (SPS) technique. Journal of Materials Science. 2005;40(8):2099-100.
Zhou A, Wang C-A, Hunag Y. Synthesis and mechanical properties of Ti₃AlC₂ by spark plasma sintering. Journal of Materials Science. 2003;38(14):3111-5.
Naguib M, Kurtoglu M, Presser V, Lu J, Niu J, Heon M, et al. Two-Dimensional Nanocrystals Produced by Exfoliation of Ti₃AlC₂. Advanced Materials. 2011;23(37):4248-53.
Shuck CE, Ventura-Martinez K, Goad A, Uzun S, Shekhirev M, Gogotsi Y. Safe Synthesis of MAX and MXene: Guidelines to Reduce Risk During Synthesis. ACS Chemical Health & Safety. 2021;28(5):326-38.
Anasori B, Gogotsi Y. MXenes: trends, growth, and future directions. Graphene and 2D Materials. 2022;7:75-9.
Michałowski PP, Anayee M, Mathis TS, Kozdra S, Wójcik A, Hantanasirisakul K, et al. Oxycarbide MXenes and MAX phases identification using monoatomic layer-by-layer analysis with ultralow-energy secondary-ion mass spectrometry. Nature Nanotechnology. 2022;17:1192-7.
Hu L, Benitez R, Basu S, Karaman I, Radovic M. Processing and characterization of porous Ti₂AlC with controlled porosity and pore size. Acta Materialia. 2012;60:6266-77.
Gonzalez-Julian J, Onrubia S, Bram M, Broeckmann C, Vaßen R, Guillon O. High-temperature oxidation and compressive strength of Cr₂AlC MAX phase foams with controlled porosity. Journal of the American Ceramic Society. 2018;101:542-52.
Yang C, Jin S, Liang B, Liu G, Duan L, Jia S. Synthesis of Ti₃AlC₂ by spark plasma sintering of mechanically milled 3Ti/xAl/2C powder mixtures. Journal of Alloys and Compounds. 2009;472(1):79-83.
Ge Z, Chen K, Guo J, Zhou H, Ferreira JMF. Combustion synthesis of ternary carbide Ti₃AlC₂ in Ti—Al—C system. Journal of The European Ceramic Society. 2003;23:567-74.
Gao L, Han T, Guo Z, Zhang X, Pan D, Zhou S, et al. Preparation and performance of MAX phase Ti₃AlC₂ by in-situ reaction of Ti—Al—C system. Advanced Powder Technology. 2020;31:3533-9.
Yeh CL, Shen YG. Combustion synthesis of Ti₃AlC₂ from Ti/Al/C/TiC powder compacts. Journal of Alloys and Compounds. 2008;466(1):308-13.
Shuck CE, Han M, Maleski K, Hantanasirisakul K, Kim SJ, Choi J, et al. Effect of Ti₃AlC₂ MAX Phase on Structure and Properties of Resultant Ti₃C₂Tr MXene. ACS Applied Nano Materials. 2019;2(6):3368-76.
Li ZY, Wang L, Sun D, Zhang Y, Liu B, Hu Q, et al. Synthesis and thermal stability of two-dimensional carbide MXene Ti₃C₂. Materials Science and Engineering B-advanced Functional Solid-state Materials. 2015;191:33-40.
Wang XH, Zhou YC. Microstructure and properties of Ti₃AlC₂ prepared by the solid-liquid reaction synthesis and simultaneous in-situ hot pressing process. Acta Materialia. 2002;50(12):3143-51.
Thakur A, Chandran B S N, Davidson K, Bedford A, Fang H, Im Y, et al. Step-by-Step Guide for Synthesis and Delamination of Ti₃C₂T. MXene. Small Methods. 2023;7.
Alhabeb M, Maleski K, Anasori B, Lelyukh P, Clark L, Sin S, et al. Guidelines for Synthesis and Processing of Two-Dimensional Titanium Carbide (Ti₃C₂Tₓ MXene). Chemistry of Materials. 2017;29(18):7633-44.
Mathis TS, Maleski K, Goad A, Sarycheva A, Anayee M, Foucher AC, et al. Modified MAX Phase Synthesis for Environmentally Stable and Highly Conductive Ti₃C₂ MXene. ACS Nano. 2021;15(4):6420-9.
Shekhirev M, Busa J, Shuck CE, Torres A, Bagheri S, Sinitskii A, et al. Ultralarge Flakes of Ti₃C₂Tₓ MXene via Soft Delamination. ACS Nano. 2022;16(9):13695-703.
Barnier P, Thévenot F. Synthesis and hot-pressing of single-phase ZrCₓO_{y} and two-phase ZrCₓO_{y} ZrO₂ materials. International Journal of High Technology Ceramics. 1986;2(4):291-307.
Peng C, Wang CA, Song Y, Huang Y. A novel simple method to stably synthesize Ti₃AlC₂ powder with high purity. Materials Science and Engineering: A. 2006;428(1-2):54-8.
Tavoosi M. The Kirkendall void formation in Al/Ti interface during solid-state reactive diffusion between Al and Ti. Surfaces and Interfaces. 2017;9:196-200.
He YH, Jiang Y, Xu NP, Zou J, Huang BY, Liu CT, et al. Fabrication of Ti—Al Micro/Nanometer-Sized Porous Alloys through the Kirkendall Effect. Advanced Materials. 2007;19(16):2102-6.

### Aspects

The following Aspects are illustrative only and do not limit the scope of the present disclosure or the appended claims. Any part or parts of any one or more Aspects can be combined with any part or parts of any one or more other Aspects.
Aspect 1. A method, comprising: forming a porous MAX-phase material.
Aspect 2. The method of Aspect 1, wherein the method comprises processing (i) a carbide and/or nitride that comprises the metal M of the MAX-phase material, (ii) an amount of the A-group element of the MAX-phase material, and (iii) an amount of the metal of the MAX-phase material, the amount of the metal of the MAX-phase material optionally being in powdered or porous form. The carbide and/or nitride can be in powder form. The A-group element can be present in powder form.

The amount of the metal of the MAX-phase material can be in powdered form. The amount of the metal of the MAX-phase material can also be in porous form, such as a sponge. Titanium sponge is considered a particularly suitable form.
Aspect 3. The method of Aspect 2, wherein the porous form is characterized as a sponge. A sponge can be in comparatively coarse form, for example from about 40 microns to about 250 microns (i.e., 60-325 mesh). Powder can have a particle size of less than 325 mesh.
Aspect 4. The method of any one of Aspects 2-3, wherein (i), (ii), and (iii) are present such that there is an excess of the A-group element of the MAX-phase material.
Aspect 5. The method of any one of Aspects 1-4, wherein the processing comprises milling.
Aspect 6. The method of any one of Aspects 1-5, wherein the processing comprises sintering.
Aspect 7. The method of any one of Aspects 1-6, further comprising reducing the porous MAX-phase material to particulate form.
Aspect 8. The method of Aspect 7, wherein reducing the porous MAX-phase material to particulate form comprising crushing the porous MAX-phase material. The crushing can be free of milling and/or ball milling.
Aspect 9. The method of any one of Aspects 1-8, further comprising forming a MXene material from the porous MAX-phase material.
Aspect 10. A MAX-phase material, the MAX-phase material made according to any one of Aspects 1-9.
Aspect 11. A MXene material, the MXene material formed by removal of the A-group element of a MAX-phase material made according to any one of Aspects 1-10.
Aspect 12. A porous MAX-phase material, the MAX-phase material optionally reduceable to particulate form by hand. The porous MAX phase material can have a porosity of up to about 30%, 40%, 50%, or even 60% in some embodiments. The porous MAX phase material can have a porosity of up to about 50%, up to about 45%, up to about 40%, up to about 35%, up to about 30%, up to about 25%, up to about 20%, up to about 15%, up to about 10%, or even up to about 5%.
Aspect 13. The porous MAX-phase material of Aspect 12, wherein the porous MAX-phase material comprises Ti₃AlC₂.
Aspect 14. A method, comprising forming a MXene from a porous MAX-phase material. The MXene can be formed by way of wet-chemical etching, for example by using HCl as an etchant.
Aspect 15. The method of claim 14, wherein the MXene comprises Ti₃C₂Tₓ.
Aspect 16. The method of any one of Aspects 14-15, wherein the MXene comprises a plurality of flakes.
Aspect 17. The method of Aspect 16, wherein a flake has a cross-sectional dimension of from about 4.5 to about 6.0 μm. The cross-sectional dimension can be in the range of from about 4.7 to about 6 μm, or from about 4.9 to about 5.8 μm, or from about 5.1 to about 5.7 μm, or from about 5.2 to about 5.6 μm.
Aspect 18. The method of Aspect 14, further comprising forming a free-standing film from the MXene.

Aspect 19. The method of Aspect 14, wherein the MXene has a conductivity in the range of from about 12,000 to about 17,000 S/cm.

Aspect 20. The method of Aspect 19, wherein the MXene has a conductivity in the range of from about 13,000 to about 15,000 S/cm.

What is claimed:

1. A method, comprising: forming a porous MAX-phase material.

2. The method of claim 1, wherein the method comprises processing (i) a carbide and/or nitride that comprises the metal M of the porous MAX-phase material, (ii) an amount of the A-group element of the MAX-phase material, and (iii) an amount of the metal of the porous MAX-phase material, the amount of the metal of the porous MAX-phase material optionally being in powdered or porous form.

3. The method of claim 2, wherein the porous form is characterized as a sponge.

4. The method of claim 2, wherein (i), (ii), and (iii) are present such that there is an excess of the A-group element of the porous MAX-phase material.

5. The method of claim 1, wherein the processing comprises milling.

6. The method of claim 1, wherein the processing comprises sintering.

7. The method of claim 1, further comprising reducing the porous MAX-phase material to particulate form.

8. The method of claim 7, wherein reducing the porous MAX-phase material to particulate form comprising crushing the porous MAX-phase material.

9. The method of claim 1, further comprising forming a MXene material from the porous MAX-phase material.

10. A MAX-phase material, the MAX-phase material made according to claim 1.

11. A MXene material, the MXene material formed by removal of the A-group element of a MAX-phase material made according to claim 1.

12. A porous MAX-phase material, the porous MAX-phase material optionally reduceable to particulate form by hand, the porous MAX phase material optionally having a porosity of up to about 60%.

13. The porous MAX-phase material of claim 12, wherein the porous MAX-phase material comprises Ti3AlC2.

14. A method, comprising forming a MXene from a porous MAX-phase material.

15. The method of claim 14, wherein the MXene comprises Ti₃C₂Tₓ.

16. The method of any one of claim 14, wherein the MXene comprises a plurality of flakes.

17. The method of claim 16, wherein a flake has a cross-sectional dimension of from about 4.5 to about 6.0 μm.

18. The method of claim 14, further comprising forming a free-standing film from the MXene.

19. The method of claim 14, wherein the MXene has a conductivity in the range of from about 12,000 to about 17,000 S/cm.

20. The method of claim 19, wherein the MXene has a conductivity in the range of from about 13,000 to about 15,000 S/cm.
